(19) United States
(12) Patent Application Publication
(10) Pub. No.: US 2012/0072972 A1
(43) Pub. Date: Mar. 22, 2012

(54) SECONDARY CREDENTIALS FOR BATCH SYSTEM

(75) Inventors: David L. Christiansen, Woodinville, WA (US); Chris Crall, Seattle, WA (US); John Michener, Sammamish, WA (US); Yi Zeng, Bothell, WA (US); Haitao Li, Sammamish, WA (US)

(73) Assignee: Microsoft Corporation, Redmond, WA (US)

(21) Appl. No.: 12/885,622

(22) Filed: Sep. 20, 2010

(51) Int. Cl. H04L 9/32

(52) U.S. Cl. 726/5

(57) ABSTRACT

A batch job system may create a second set of credentials for a user and associate the second set of credentials with the user in an authentication server. The second set of credentials may allow computers running the batch jobs to have user-level authentication for execution and reporting of results. The second set of credentials may be a single sign on type of credential, and may consist of a virtual smartcard that each worker computer may use for authentication. In some embodiments, authentication requests may be routed to a virtual or physical Hardware Security Module.

### BACKGROUND

Computer batch jobs are jobs that may be performed remotely, such as on a cluster of computers, a cloud computing system, or some other computer system different from a user's client device. In many cases, batch jobs may take a considerable amount of time, and some batch jobs may take several hours, days, weeks, or even longer to process.

In many cases, batch jobs may operate with user level authentication and security. The user level authentication may be used to perform the batch job in isolation from other users so that other users cannot access the input, output, or processing of the job. Such systems may allow a batch job to write results from the batch job to a user's client computer or some other location accessible to the user.

### SUMMARY

A batch job system may create a second set of credentials for a user and associate the second set of credentials with the user in an authentication server. The second set of credentials may allow computers running the batch jobs to have user-level authentication for execution and reporting of results. The second set of credentials may be a single sign on type of credential, and may consist of a virtual smartcard that each worker computer may use for authentication. In some embodiments, authentication requests may be routed to a virtual or physical Hardware Security Module.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for executing batch jobs.

FIG. 2 is a timeline illustration of an embodiment showing a method for batch job processing.

FIG. 3 is a flowchart illustration of an embodiment showing a method for processing a batch job using a software smartcard certificate.

FIG. 4 is a timeline illustration of an embodiment showing a method for processing a batch job using remoted smartcard requests.

### DETAILED DESCRIPTION

A batch job system may create a second set of user credentials for use in executing batch jobs on remote computing devices. The second set of user credentials may be based on a long term credential scheme, such as a smartcard or security certificate. The second set of credentials may be associated with a user's normal credentials though an authentication server, and the batch job may execute and return results using the second set of credentials.

The second set of credentials may allow a batch job to execute even after a user changes their password or makes changes to their normal credentials. Also, the second set of credentials may be revoked at any time after the job is set up without revoking or affecting the user's normal credentials.

In one embodiment, each remote computing device may have a software driver that may emulate a hardware reader for a smartcard to create a software smartcard reader. The remote computing device may be issued a smartcard certificate that may operate with the software smartcard reader to provide authentication.

In another embodiment, each remote computing device may query an authentication server that may contain a hardware or software smartcard to provide Kerberos tickets for authentication. In such a case, the Kerberos tickets may be used for authentication while the credentials may be in a secure location.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

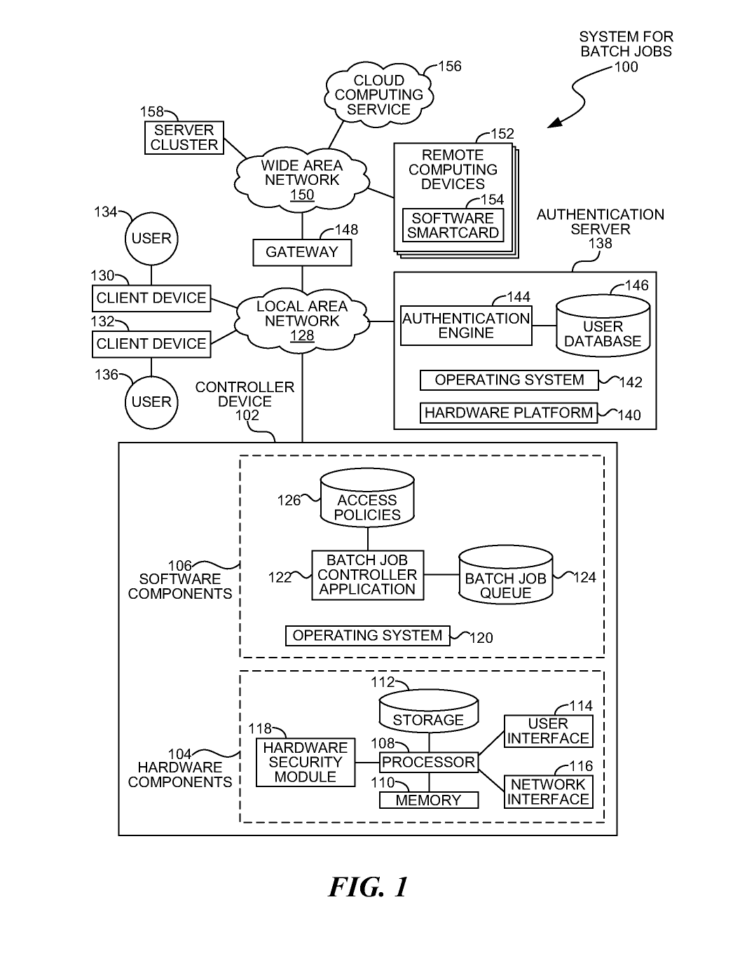

FIG. 1 is a diagram of an embodiment 100, showing a system for executing batch jobs on remote devices. Embodiment 100 is a simplified example of a hardware and software environment in which batch jobs may be performed on remote devices using a second set of user credentials.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a typical environment in which batch jobs may be executed. Batch jobs are a term used in this specification and claims to refer to computing operations performed at the behest of a user but performed on a device other than the device the user may be using. In a typical scenario, a user may login to a client device and cause a batch job to be performed on a server computer, cloud computing service, server cluster, or other computing platform. The batch job may be performed under the user's identification and using the user's credentials.

Batch jobs, as defined in this specification and claims, may be performed on one or more computing devices. In some cases, a batch job may be executed on a single computing platform, such as a server or desktop computer or even small portable device such as a cellular telephone. In other cases, a batch job may be performed on a high performance computing device with multiple processors. In still other cases, the batch job may be performed on a server cluster with many server computers that may operate in parallel. In yet other cases, the batch job may be performed in a cloud computing environment that may contain many hundreds or thousands of computing devices.

One use scenario may be for a user to be an engineer who creates a batch job that performs computational fluid dynamics calculations. In many cases, such a batch job may consume much more computing power than a typical desktop client computer the user used to create the batch job. The batch job may be transmitted to a controller device and performed by a high performance computer or cluster of high performance computers over the course of several hours or even days.

In another use scenario, a batch job may be executed by a banking supervisor to reconcile depositor's bank accounts every night at midnight. Such a batch job may be a periodic batch job that executes once a day every business day. The batch job may be transmitted to the controller device and performed by a server computer.

In both use scenarios, the batch job may operate independently from the client device and on a remote computing system. Further, the batch job may operate with the user's credentials.

Because the batch jobs operate with the user's credentials, user level access limitations may be enforced. In many environments, a batch job may be performed on a computing platform that may be used by business competitors or other users to whom access to the batch job may be restricted. For example, a company may offer a cloud computing service in a datacenter that may be open to any customer to perform any type of operation. In such an example, each user of the computing service may have user-level access control to their batch jobs which may prohibit other users from gaining access to the batch job.

In many systems, each user may have full access to their batch jobs. Full access may allow the user to start, stop, pause, resume, prioritize, and perform other administrative tasks for the batch jobs. The user may also read and write data to the batch job and receive the output of the batch job.

In some systems, an administrator for a batch job computing service may have access to perform some administrative actions, such as shut down, stop, pause, or resume a batch job. In such systems, the administrator may not have access to the data within the batch job. Access to the data may be restricted to only the user or other users to whom the user has given permission. In some cases, a user may grant read permission but not write permission to another user, for example.

Batch jobs associated with user credentials allows user level policies to be applied to the batch jobs. For example, certain users or groups of users may be allowed access to certain computing resources. In one use scenario, a high level employee who may have access to sensitive internal or classified information may be restricted to access only secure computing resources, such as an internal server cluster. In the same use scenario, a lower level employee who may have limited access to sensitive internal documents within a company may be allowed access to a commercially available cloud computing service, where the cloud computing service may be accessed by competitors or other people outside of the organization.

The user level policies may define access limitations or permissions for specific users. In some cases, the user level policies may define which types of computing services may be accessed, for how long those services may be accessed, or other restrictions on a user's access to the computing services.

When a batch job may be created and sent to a controller device, a user may access the controller device using a first set of credentials, such as a user identification and password. In some cases, the first set of credentials may be a hardware smartcard, personal identification number, certificate, or other set of credentials.

The controller device may use a second set of user credentials for the batch job. The second set of user credentials may be associated with the user so that the second set of credentials allows the batch job to be executed as the user and using the same authority as the first set of credentials.

Because a second set of credentials are used in the batch job, several scenarios are enabled.

In one scenario, a user may access a controller device using a conventional username and password. The controller device may obtain a second set of credentials and cause a batch job to be executed using the user's second set of credentials. While the batch job is executing, the user's password may expire or the user may otherwise change the password. At the point the user changes the password, the first set of credentials are not valid and are replaced with an updated version of the credentials. If the batch job were being executed using the first set of credentials, the batch job may not be able to authenticate because the batch job no longer has a valid set of credentials.

Because the batch job may operate with a second set of credentials, the user's first set of credentials may be updated, changed, or managed without affecting the ability of the batch job to function.

In another scenario, a user may again access a controller device using a first set of credentials. The controller device may obtain a second set of credentials and cause a batch job to be executed using the user's second set of credentials. At some point prior to finishing the batch job, a security breach in the remote computing service may be suspected or detected. In response to the security breach, the second set of credentials may be revoked.

When the second set of credentials may be revoked, the batch job may be prevented from further access to any user-related data or systems. For example, the batch job may not be able to access a user-controlled system to report results from the batch job. In many embodiments, the systems on which the batch job operates may attempt to re-authenticate in response to the expiration of an authentication ticket, such as in a Kerberos system, for example. Such a re-authentication request may fail because the second set of credentials may be revoked. The failure may cause the batch job to halt.

In such a scenario, the operations of a batch job on a remote computing service may be stopped by performing an operation within a locally controlled environment. The remote computing service may operate on a hardware platform controlled by a third party and for which a user may not have direct access. However, the second set of user credentials may be managed within a controlled environment in which the user has access.

The second set of credentials may be a smartcard authentication, which may be implemented in hardware or software. A smartcard may be a security device that may decrypt incoming information using a secret key that may be stored in the smartcard. In a hardware implementation, the hardware smartcard may have a small processor that may receive incoming information and perform the decryption. The hardware implementation may have various features that may resist or prevent accessing the secret key stored inside the smartcard.

In a software implementation, the logic and secret key of a smartcard may be embodied in a security certificate. The security certificate may be a software version of the hardware smartcard and may be accessed using a driver that may emulate a hardware smartcard. In some embodiments, the security certificate may operate like a hardware smartcard in that it may be capable of decrypting an input while being resistant to determining the internal secret.

In another implementation, the remote devices may be configured with a redirection driver that may receive any requests for a smartcard and redirect the requests to anther device. For example, such requests may be redirected to a controller device where a software smartcard certificate may be stored, or where a hardware smartcard or hardware security module may be located. Such an implementation may ensure that the smartcard information is maintained in a secure environment even while the computing service may not be within a secure environment.

The second set of credentials may be a longer-lived set of credentials than the first set of credentials. For example, a smartcard-type credential may not have any expiration date, while a username and password set of credentials may be set to expire every 90 days unless the password is changed.

Embodiment 100 illustrates a controller device 102 that may receive batch job requests from client devices 130 and 132. An authentication server 138 may verify credentials received from the client devices 130 and 132 for the controller device 102. The controller device 102 may send batch jobs to various remote computing services, including various remote computing devices 152, cloud computing service 154, and a server cluster 158.

A controller device 102 is illustrated having hardware components 104 and software components 106. The controller device 102 as illustrated represents a conventional computing device, although other embodiments may have different configurations, architectures, or components.

The controller device 102 may be a server computer, desktop computer, or comparable device. In some embodiments, the controller device 102 may be a laptop computer, netbook computer, tablet or slate computer, wireless handset, cellular telephone, or any other type of computing device.

The hardware components 104 may include a processor 108, random access memory 110, and nonvolatile storage 112. The hardware components 104 may also include a user interface 114 and network interface 116.

The hardware components 104 may include a hardware security module 118. A hardware security module 118 may be a type of secure cytoprocessor for managing digital keys. The hardware security module 118 may be difficult to attack from an outside device, and may be physically protected in a secure area.

In many embodiments, a hardware security module 118 may be used to store and process smartcard credentials for remote devices.

The software components 106 may include an operating system 120 on which several applications and databases may operate.

A batch job controller application 122 may receive batch job requests, apply various policies defined in access policies 126, and place the batch jobs in a batch job queue 124. When the batch job is ready to be executed, the batch job controller application 122 may communicate with a remote computing service and cause the batch job to execute.

The batch job controller application 122 may provide credentials or a mechanism for authentication for batch jobs being executed on remote computing services. The credentials for a batch job may be user credentials, but a second set of user credentials that are separate from the user credentials used to authenticate the user when causing the batch job to execute.

The second set of credentials may be created at the time a batch job is prepared for execution. In some embodiments, a separate set of credentials may be created for each batch job. Such embodiments may be useful in cases where it may be useful to have control over each batch job separately and independently.

In some embodiments, the remote computing service may consist of many different computers or groups of computers. In such embodiments, some computers may be trusted more or less than other computers. In some embodiments, a separate set of credentials may be created for each of the computers or groups of computers being used to execute a single batch job. Such embodiments may be useful in cases where a user or administrator may wish to cancel or revoke the credentials of a single computing device or group of computing devices during the execution of the batch job.

The batch job controller application 122 may have a second set of credentials prior to receiving a batch job in some embodiments. In one example, an administrator may configure a computing service with user identities for each of the permitted users of the computing service. When the user identities are configured, these second set of user credentials may be associated with each user's local credentials by storing the second set of credentials in an authentication server 138. Each time a batch job may be prepared for execution, the batch job controller application 122 may retrieve the second set of credentials and cause the batch job to be executed using the second set of credentials.

The access policies 126 may define which users or groups of users may have access to which, if any, remote computing services. In some cases, certain groups or types of users may have access to a specific group or type of remote computing service, while other users may be restricted from accessing the same service. For example, a remote computing service may be established for executing secure financial transactions. An access policy may be defined allowing only certain users to have the ability to send batch jobs to the remote computing service.

The batch job queue 124 may be a repository or database that stores batch jobs prior to execution. In some cases, a batch job may be scheduled to execute at a certain time, such as midnight in a particular time zone. In another example, a batch job may be scheduled to execute when another batch job completes or when a specific set of resources becomes available.

The example of embodiment 100 illustrates a local area network 128 in which client devices 130 and 132 may communicate with the controller device 102 and the authentication server 138. Within a local area network 128, there are often physical security measures in place to limit access to the network. For example, a local area network may be within a home or within an office building. As such, the physical connection to the network may provide some access control to the devices on the network. Because of the physical security, the credentials used to access resources on the local area network may be less stringent than credentials used to access resources from outside the local area network.

Within the local area network 128, users 134 and 136 may login to client devices 130 and 132, respectively. During a login operation, the devices 130 and 132 may perform a query to the authentication server 138 to determine if the users have permission to login. If the users have permission, the login may be completed. If the users do not have permission or if the credentials presented by the users do not match the credentials stored in the authentication server 138, the user login may be denied.

In a typical login sequence, a user may present a user identification, which may be a user name, and a password. In some instances, a user may have a hardware smartcard that may be inserted into a smartcard reader. Such a user may or may not have to also enter a personal identification number or password. The credentials may be verified by communicating with the authentication server 138.

The authentication server 138 may be a separate device from the controller device 102. In some embodiments, the functions of the authentication server 138 and the controller device 102 may be combined into the same hardware platform.

The authentication server 138 may provide authentication services for devices connected to the local area network 128 as well as other devices. The authentication services may be in the form of a Lightweight Directory Access Protocol (LDAP) or other similar services.

In some embodiments, the authentication server 138 may provide Kerberos-based authentication. Kerberos is one mechanism for devices connected to a network to prove their identity to each other. In a simplified manner, a Kerberos system operates with an authentication server that may issue a ticket in response to a proper authentication. The ticket may be passed to another device, which may accept the ticket as proof of authentication. With a Kerberos system, the authentication server 138 may authenticate requests and issue tickets.

The architecture of the authentication server 138 may have a hardware platform 140, an operating system 142, and an authentication engine 144 which may access a user database 146. The hardware platform 140 may represent the same hardware components as shown for the hardware components 104 for the controller device 102.

The authentication engine 144 may be a mechanism for receiving and responding to authentication requests. The authentication engine 144 may use the Kerberos protocol, or any other authentication protocol for authentication. In some cases, the authentication engine 144 may use Internet Key Exchange, IPSec, Point to Point Protocol, Transport Layer Security, or other cryptographic protocols alone or in combination with other protocols.

The user database 146 may be an LDAP database or other database that may store user information.

The remote computing services may take on several forms. In the example of embodiment 100, the remote computing services may be accessed through a gateway 148 to a wide area network 150. In other embodiments, the remote computing services may be located within the local area network 128.

The remote computing services may consist of one or more computing devices on which a batch job may be executed. In many large batch jobs, multiple processors may be used to execute a batch job. In some large batch jobs, many hundreds or thousands or even hundreds of thousands of devices may be used to perform a batch job.

One example of a remote computing service may be a set of remote computing devices 152. The remote computing devices 152 may be server computers or other high powered computers that may be tailored for performing computationally heavy operations. In another example, the remote computing devices 152 may be a set of desktop computers that are configured to perform a batch job as a background process or when no other operations are being performed on the device.

Each remote device 152 may have a mechanism to authenticate using credentials. The credentials may allow a batch job to have access to a user-accessible location to store results or to access user-supplied data. For example, a batch job may access a database within the local area network 128 to retrieve data. During such a retrieval, the batch job may authenticate and access the data using the second set of user credentials supplied by the controller device 102.

One mechanism for providing authentication credentials may be to transmit a software smartcard 154 to each of the remote computing devices 152. In such an embodiment, the batch job may contain the credentials to authenticate the user.

In another mechanism, each remote computing device 152 may contain a remoting application for a smartcard query. The remoting application may intercept any requests for a smartcard query and forward or remote the query to another device. The remoting application may be configured to forward the query to the controller device 102 in some embodiments, to the authentication server 138 in other embodiments, or to yet another device not shown in embodiment 100.

A cloud computing service 156 may be a remote service that provides computing services using a datacenter. In some embodiments, the cloud computing service may be a datacenter that provides computing services for many different clients, including the controller device 102. In some such embodiments, the cloud computing service may or may not have a notion of multiple devices on which a batch job may execute. In some embodiments, the cloud computing service 156 may have multiple virtual machines on which a batch job may execute.

A server cluster 158 may be a group of servers that may operate together to provide computing services. In some embodiments, a server cluster 158 may have load balancing capabilities or other functions that may allow efficient utilization of the computing resources.

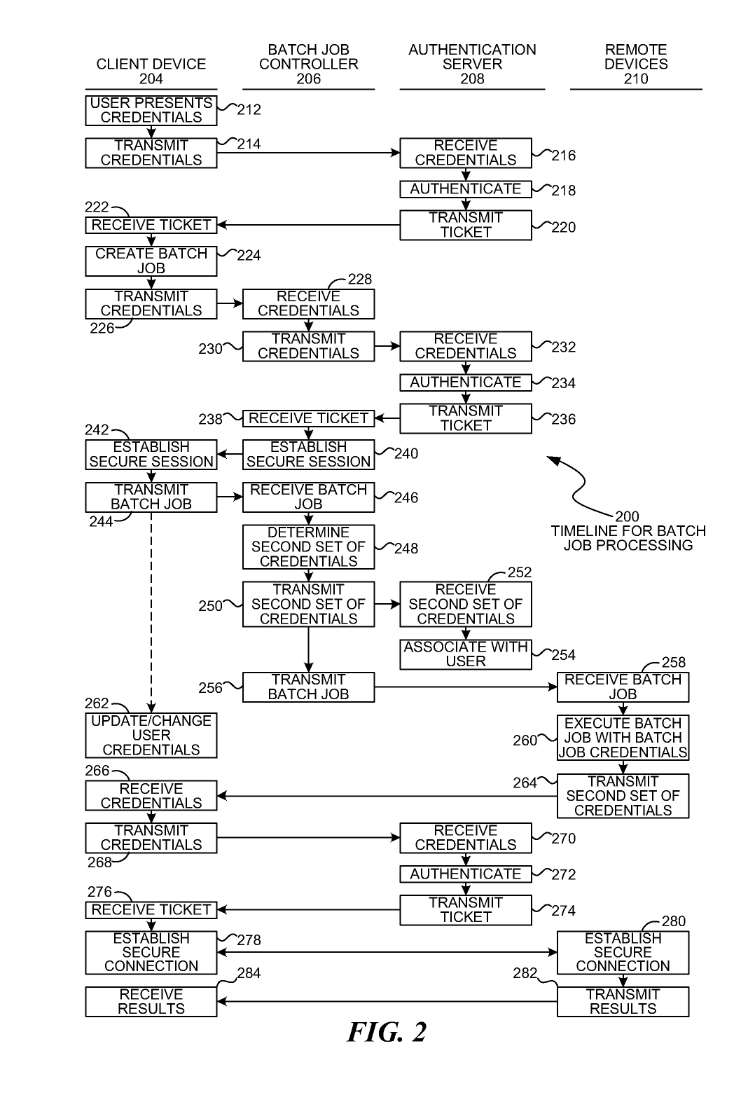

FIG. 2 is a timeline illustration of an embodiment 200 showing a method for processing a batch job. The process of embodiment 200 is a simplified example of how a client device 204, batch job controller 206, authentication server 208, and remote devices 210 may interact to setup and execute a batch job.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates the operations of a client device 204 in the left hand column, the batch job controller 204 in the second column, the authentication server 208 in the third column, and the remote devices 210 in the right hand column The client device 204 may correspond with the devices 130 or 132 of embodiment 100. The batch job controller 204 may correspond with the controller device 102. The authentication server 208 may correspond with the authentication server 138, and the remote devices 210 may correspond with any of the various computing services of embodiment 100.

Embodiment 200 illustrates an embodiment where a batch job controller may transmit user credentials to a remote device. The user credentials may be in the form of a smartcard certificate in some cases.

In block 212, the client device 204 may receive user credentials and may transmit the credentials in block 214 to the authentication server 208. The user credentials may be in the form of a username and password, smartcard credentials, or any other type of credentials.

The authentication server 208 may receive the credentials in block 216, authenticate the credentials in block 218, and transmit an authentication ticket in block 220. The ticket may be received by the client device 204 in block 222. The authentication server may authenticate the credentials by comparing the received credentials against credentials stored in a user database. In some cases, the credentials may involve decrypting a transmission using a public key private key encryption system.

The ticket transmitted by the authentication server 208 may represent a Kerberos ticket in some embodiments. The ticket may be a message that may be recognized by the client device 204.

The client device 204 may create a batch job in block 224. The batch job may be any type of computing job that may be performed on another computing device. In some embodiments, a batch job may be a large, computationally expensive project, such as large engineering simulations or other projects with complex computations. In other embodiments, a batch job may be a scheduled event, such as performing data collection at a predetermined interval.

In block 226, the client device 204 may transmit credentials to the batch job controller 206, which may receive credentials in block 228. The batch job controller 206 may transmit the credentials in block 230 to the authentication server 208. The authentication server 208 may receive the credentials in block 232, authenticate the credentials in block 234, and transmit a ticket in block 236 to the batch job controller 206. The batch job controller 206 may receive the ticket in block 238. Once the ticket is received, a secure session may be established in blocks 240 and 242 between the client device 204 and the batch job controller 206.

The operations of blocks 226 through 238 illustrate one method for authenticating between the client device 204 and the batch job controller 206. Other embodiments may use different authentication sequences and various authentication mechanisms to establish a communication session.

In some embodiments, the communication session between a client device 204 and a batch job controller 206 may not be a secured connection. For example, in a domain environment within a local area network, the connections between the various devices may be trusted based on a previous authentication or based on the known physical location of the various devices.

Once the communication session is established between the client device 204 and the batch job controller 206, the client device 204 may transmit a batch job in block 244, which may be received by the batch job controller in block 246.

The batch job controller 206 may determine a second set of credentials in block 248. In some embodiments, the second set of credentials may be created after the batch job is received. In other embodiments, the second set of credentials may be created prior to receiving the batch job. In such embodiments, the batch job controller 206 may retrieve the second set of credentials from a storage location in block 248.

In block 250, the batch job controller 206 may transmit the second set of credentials to the authentication server 208, which may receive the second set of credentials in block 252. The authentication server 208 may associate the second set of credentials with the user in block 254.

The act of associating the second set of credentials in block 254 may give the second set of credentials “first class” status as credentials. “First class” status may indicate that the set of credentials are not dependent on any other set of credentials. In such embodiments, the user's first set of credentials presented in block 212 and the second set of credentials may both be considered “first class” credentials. For example, either the first set or second set of credentials may be changed without affecting the other. One set may be revoked without revoking the other, and one set may be changed or updated without changing the other.

The batch job controller 206 may transmit the batch job in block 256 to the remote devices 210, which may be received in block 258. In some embodiments, the batch job controller 206 may send portions of the batch job to individual remote devices. In such embodiments, the batch job controller 206 may contact each remote device individually and send the portion to the device. For simplicity, the actions of all of the remote devices are illustrated as the operation of one remote device in embodiment 200. In some such embodiments, each remote device may operate independently.

The remote devices may execute the batch job with the user credentials in block 260. The user credentials may allow the batch job to login to the remote device with a user account in some cases. The user credentials may be used by the batch job to access data associated with the user account. For example, a database may be protected from access by non-authenticated users. In such an example, a batch job may gain access to the database by using the user's credentials provided by the batch job controller.

After the batch job has been transmitted to the remote devices 210, the user may update or change the first set of credentials in block 262. For example, the user password may be updated or changed. Even though the user's first set of credentials may be changed in block 260, the second set of credentials used by the batch job may remain unaffected.

The remote devices 210 may transmit the second set of credentials in block 264, which may be received by the client device 204 in block 266. The client device 204 may transmit the credentials in block 268 to the authentication server 208, which may receive the credentials in block 270. The authentication server 208 may authenticate the credentials in block 272 and transmit a ticket in block 274. The client device 204 may receive the ticket in block 276 and a secure communications connection may be established in blocks 278 and 280.

As with blocks 226 through 238 above, the operations of blocks 264 through 276 may be different for other embodiments.

Once the communications channel is created in blocks 278 and 280, the remote devices 210 may transmit results in block 282, which may be received by the client device 204 in block 284.

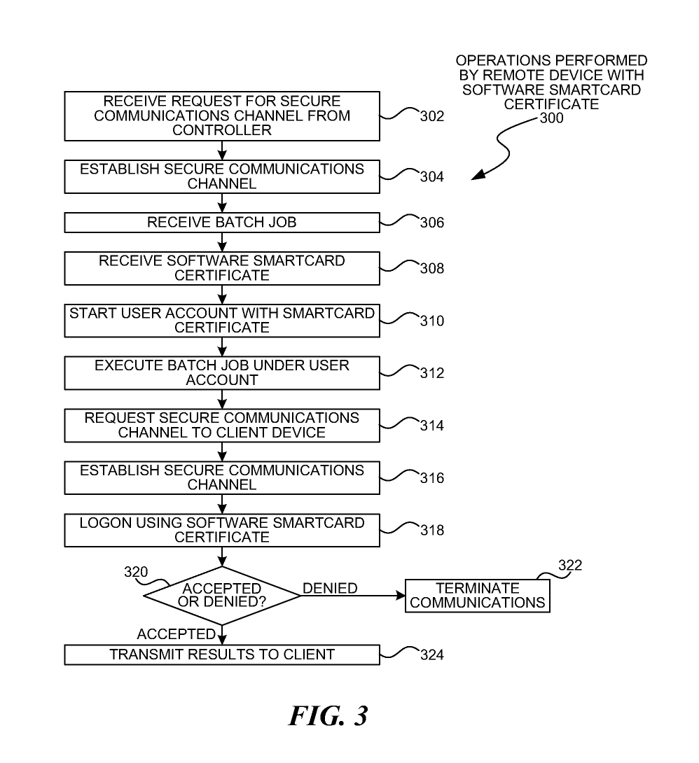

FIG. 3 is a timeline illustration of an embodiment 300 showing operations performed by a remote device in an embodiment that uses a software smartcard certificate. The operations of embodiment 300 are a simplified example of operations that a remote device may perform when performing a batch job.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates the operations of a remote device with a smartcard certificate. The smartcard certificate may be a security certificate that may be used to encrypt and decrypt data. The smartcard certificate may contain a private key and public key, in some embodiments. The private key may be a secret contained in the certificate and may be very difficult to extract from the certificate.

In block 302, a request for a secure communications channel may be received from a batch job controller. In response, a secure communications channel may be created in block 304. The batch job may be received in block 306. A software smartcard certificate may be received in block 308.

The secure communications channel may be useful in embodiments where the remote devices may be located outside of a local area network, such as remote devices located on the Internet. The secure channel may be created using Secure Sockets Layers (SSL) or other communications protocols.

In many cases, the software smartcard certificate may be credentials that have full user level access to any system or database for which the user has permission. As such, the software smartcard certificate may be transmitted using secure channels to avoid having the credentials stolen or misused.

The smartcard certificate may be used in place of a hardware smartcard when performing operations such as starting a user account in block 310 and executing the batch job using that account in block 312.

In block 314, a request may be made to establish a secure communications channel to the client device, which may be established in block 316. Once the channel is established, a login may be attempted in block 318 using the smartcard certificate.

If the login is denied in block 320, the communications may be terminated in block 322. If the login is accepted in block 320, the results may be transmitted to the client in block 324.

In one use scenario, the smartcard credentials may be revoked while the batch job is executing. For example, a security breach may occur on one of the remote devices. Rather than attempting to access each remote device and stop the batch job, an administrator may revoke the smartcard credentials so that the breached device can no longer have access to the user identity.

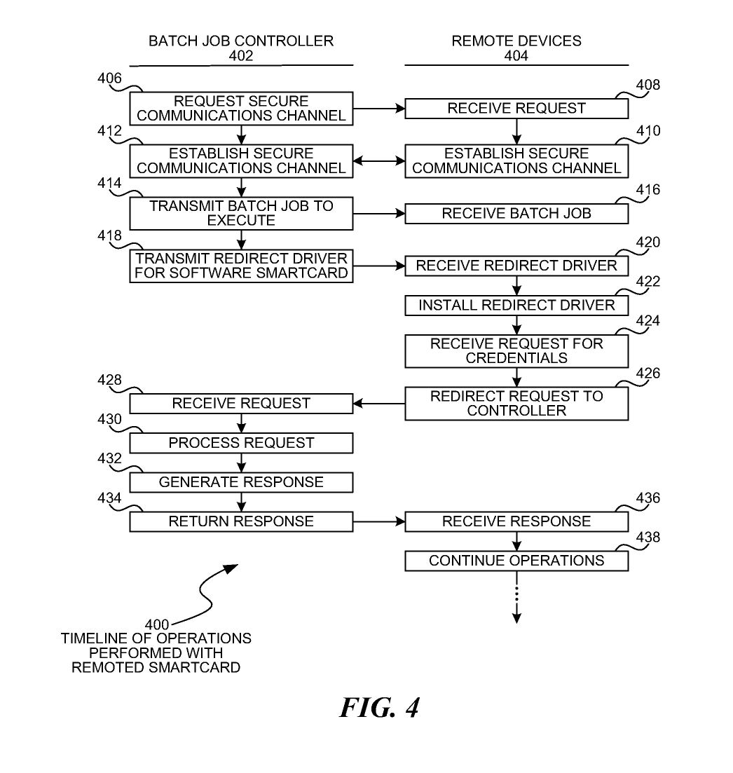

FIG. 4 is a timeline illustration of an embodiment 400 showing operations performed with a remoted smartcard. The process of embodiment 400 is a simplified example of how a batch job controller 402 and remote devices 404 may interact using a redirected smartcard configuration.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of interactions that may occur between a batch job controller 402 and remote devices 404 when the remote devices 404 are configured with a redirect or remoting system for smartcard authentications. The remote devices 404 may have a driver installed that intercepts requests for a smartcard authentication and transmits the request over a secure channel to another device. In the embodiment 400, the requests may be redirected to the batch job controller 402 which may process the request.

Embodiment 400 is an example of a system where smartcard authentication is used, but the smartcard credentials may be located within a controlled environment. In comparison, embodiment 300 is an example of an embodiment where smartcard certificates may be transmitted to each of the remote devices. Embodiment 400 may be an example of a system where the smartcard credentials may be located at a single location and access to the smartcards may be restricted.

In block 406, the batch job controller 402 may request a secure communications channel. The request may be received by the remote devices 404 in block 408 and a secure communications channel may be established in blocks 410 and 412.

The batch job controller 402 may transmit a batch job to execute in block 414, which may be received by the remote device 404 in block 410.

In block 418, the batch job controller 402 may transmit a redirect driver for a smartcard, which may be received in block 420 by the remote device 404. The redirect driver may be installed in block 422.

During the execution of the batch job, the remote device 404 may generate requests for authentication credentials. A request may be intercepted by the redirect driver in block 424 and redirected to the controller in block 426.

The request may be received by the batch job controller 402 in block 428, processed in block 430, and a response generated in block 432. The response may be transmitted in block 434 and received by the remote device 404 in block 436. The response may be used to satisfy the credential request and the remote device 404 may continue operating in block 438.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a connection request from a client device, said connection request comprising a user identity;
authenticating said user identity by receiving a first set of user credentials from said client device and authenticating said first set of user credentials against an authentication server;
receiving a batch job from said client device;
determining a second set of user credentials, and causing said second set of user credentials to be associated with said user identity at said authentication server;
identifying a computing device to perform said batch job; and
transmitting said batch job to said computing device such that said batch job is executed with said second set of user credentials.

2. The method of claim 1 further comprising:
changing said first set of user credentials after said batch job is transmitted without changing said second set of user credentials.

3. The method of claim 1 further comprising:
revoking said second set of user credentials after said batch job is transmitted and before said batch job is completed, said revoking causing said batch job to be disallowed to return further results.

4. The method of claim 1, said second set of user credentials comprising a software smartcard certificate.

5. The method of claim 1 further comprising:
receiving a request for authentication from said computing device, said request for authentication comprising an encrypted version of said second set of credentials;
decrypting said encrypted version of said second set of credentials to produce a decrypted authentication request;
performing an authentication using said decrypted authentication request; and
returning an authentication ticket to said computing device.

6. The method of claim 5, said authentication being performed against a hardware security module.

7. The method of claim 5, said decrypting being performed using a private key associated with said computer processor.

8. The method of claim 1, said second set of user credentials being determined in response to a request for said batch job, said second set of user credentials being associated with said batch job.

9. A system comprising:
an authentication server that receives authentication requests and authenticates valid authentication requests; and
a controlling server having a processor, said controlling server using said processor to:
receive a batch job request from a client device, said batch job request comprising a user identity;
authenticate said user identity against said authentication server using a first set of credentials received from said client device;
determine a second set of credentials;
cause said authentication server to associate said second set of credentials with said user identity;
identify a computing service to perform said batch job; and
transmit said batch job to said computing service such that said computing service may execute said batch job using said second set of credentials.

10. The system of claim 9, said authentication server comprising a Lightweight Directory Access Protocol server.

11. The system of claim 9, said authentication server having a hardware security module.

12. The system of claim 11, said computing service being configured to transmit authentication requests to said authentication server, said authentication requests being for said second set of user credentials.

13. The system of claim 9, said second set of credentials being a single sign on set of credentials.

14. The system of claim 13, said second set of credentials further being a software certificate emulating a smartcard.

15. The system of claim 9, said computing service being a cloud computing service.

16. The system of claim 9, said second set of credentials being created after said batch job is received.

17. The system of claim 9, said second set of credentials being created prior to receiving said batch job.

18. A method performed on a computer processor, said method comprising:
receiving a first authentication request from a user, said first authentication request comprising a first set of credentials;
authenticating said first authentication request against an authentication server using said first set of credentials and creating an authenticated session;
receiving a first batch job from said user through said authenticated session;
determining a remote computing service to perform said batch job;
identifying a second set of credentials and associating said second set of credentials to said user by transmitting said second set of credentials to said authentication server, said second set of credentials being a smartcard certificate; and
creating a secure communications path to said remote computing service and transmitting said batch job to said remote computing service through said secure communications path such that said remote computing service may execute said batch job using said second set of credentials.

19. The method of claim 18 further comprising:
transmitting said second set of credentials to said remote computing service.

20. The method of claim 18 further comprising:
receiving a second authentication request for said second set of credentials from said remote computing service;
forwarding said second authentication request to a hardware security module;
receiving a response from said hardware security module; and
returning said response to said remote computing service.
